(19) United States
(12) Patent Application Publication
(10) Pub. No.: US 2009/0187985 A1
(43) Pub. Date: Jul. 23, 2009

(54) METHOD FOR DETERMINING RANGE OF AVAILABLE FUNCTIONS OF INFORMATION APPARATUS

(75) Inventor: Kurato AIHARA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/272,115

(22) Filed: Nov. 17, 2008

(30) Foreign Application Priority Data
Jan. 23, 2008 (JP) 2008-012602

(51) Int. Cl. G06F 21/00

(52) U.S. Cl. 726/17

(57) ABSTRACT

According to an aspect of an embodiment, a method of controlling an information apparatus has performing authentication of a user of the information apparatus, performing authentication of an administrator of the information apparatus, determining a range of available functions of the information apparatus corresponding to successful authentication of the user and the administrator and permitting the user to utilize the range of available functions of the information apparatus.

### BACKGROUND

The present art relates to an information apparatus that authenticates a user and an administrator.

Organizations such as companies have provided employees with information apparatuses such as personal computers. Such an information apparatus must always be monitored and managed by the section manager of a user or a system administrator (hereafter, both will be referred to as “administrators”) in order to prevent leakage of confidential information from the apparatus or prevent use of the apparatus for purposes other than business purposes.

There are Japanese Laid-open Patent Publication No. 2003-30144, Japanese Laid-open Patent Publication No. 2001-282625, Japanese Laid-open Patent Publication No. 2006-227761 and Japanese Laid-open Patent Publication No. 2006-229711.

However, it is difficult for an administrator to always monitor and manage how a user is using an information apparatus. Therefore, the administrator must set the use range of the information apparatus for the user so that the information processing apparatus is not used outside the use range. Also, depending on organizations, a user may have to obtain permission from an administrator when using an information apparatus. This makes the management of the apparatus troublesome thereby increasing the burden imposed on the administrator.

Incidentally, awareness of information leakage has been raised in recent years. However, if a user loses an information processing apparatus during a business trip, the third party may be able to acquire information therefrom unless the apparatus is access-controlled in some way. Among typical access control methods is user authentication performed when a user uses his or her information apparatus. If user authentication is performed, the security level is increased as the frequency of authentication is increased.

### SUMMARY

According to an aspect of an embodiment, a method of controlling an information apparatus has performing authentication of a user of the information apparatus, performing authentication of an administrator of the information apparatus, determining a range of available functions of the information apparatus corresponding to successful authentication of the user and the administrator and permitting the user to utilize the range of available functions of the information apparatus.

### BRIEF DESCRIPTION OF THE DRAWINGS

FIG. 1 shows an example of functional blocks of an information processing apparatus according to an embodiment of the present technique;

FIGS. 2A, 2B and 2C are flowcharts showing an example of processes performed by the information processing apparatus according to this embodiment;

FIGS. 3A and 3B are drawings showing a user authentication screen and an administrator authentication screen according to this embodiment;

FIGS. 4A and 4B are drawings showing an interface selection screen and an application selection screen according to this embodiment; and

FIGS. 5A, 5B and 5C are diagrams showing cases of occurrence of a change factor according to this embodiment.

### DESCRIPTION OF THE PREFERRED EMBODIMENTS

Now, an embodiment of the present technique will be described with reference to the accompanying drawings. It should be noted that this embodiment is one working example of the technique; therefore, the technique is not limited to the embodiment unless any description intended to limit the technique is shown in the following description.

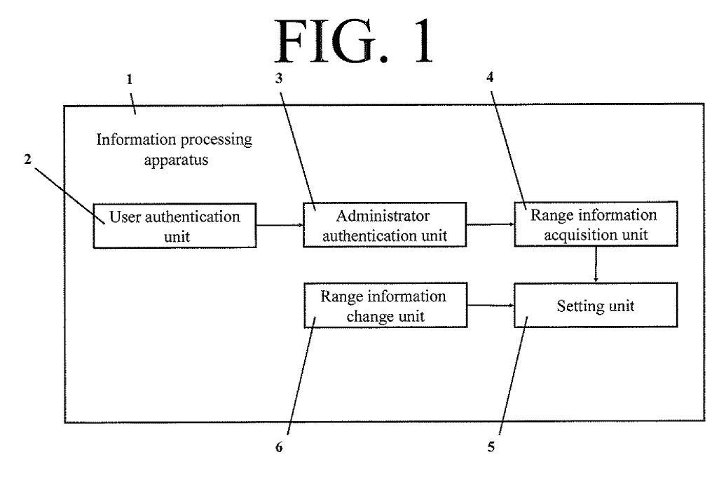

FIG. 1 shows functional blocks of an information processing apparatus according to this embodiment. An information processing apparatus 1 includes a user authentication unit 2 (first authentication unit), an administrator authentication unit 3 (second authentication unit), a range information acquisition unit 4 (acquisition unit), a setting unit 5, and a range information change unit 6 (change unit). Use of hardware resources included in the information processing apparatus 1, such as a central processing unit (CPU) and a memory allows these functional blocks to function. The range information acquisition unit 4 determines a range of available functions of the information processing apparatus 1 corresponding to successful authentication of a user and an administrator of the information processing apparatus 1. The setting unit 5 permits the user to utilize the range of available functions of the information processing apparatus 1.

The user authentication unit 2 authenticates a user who is attempting to use the information processing apparatus 1. While an authentication method requiring a user to enter a user ID and a password corresponding to the user ID is used in this embodiment, any authentication methods, including a biometric authentication method using fingerprints, veins or the like and an authentication method using an IC card (contact-type/non-contact type) such as a smart card or a Felica (registered trademark) card as a card key, may be used.

The administrator authentication unit 3 authenticates the manager of a section to which the user of the information processing apparatus 1 belongs or the administrator of a system including the information processing apparatus 1 (hereafter, both a section manager and a system administrator will be referred to as “administrators” (administrators having a predetermined relationship with the user). Also, the administrator authentication unit 3 may authenticate multiple administrators so that only when the multiple administrators are successfully authenticated, it is determined that administrator authentication has succeeded. Like the user authentication unit 2, the administrator authentication unit 3 may use any authentication method.

If the user and administrator are successfully authenticated by the user authentication unit 2 and administrator authentication unit 3, the range information acquisition unit 4 acquires information on the use range of the information processing apparatus 1 (in this embodiment, interfaces (hardware) whose use is to be permitted or prohibited, applications (software) whose use is to be permitted or prohibited, and the time within which the user may use the apparatus) as range information. The range information acquisition unit 4 may acquire range information, for example, by displaying an entry screen on a monitor included in the information processing apparatus 1 and causing the administrator to select, on the entry screen, resources whose use is to be permitted (or prohibited) or by acquiring a file in which the use range is defined.

The setting unit 5 sets the use range of the information processing apparatus 1 for the user in accordance with the range information acquired by the range information acquisition unit 4. For example, if the information processing apparatus 1 is a Windows (registered trademark)-based system, the setting unit 5 permits (or prohibits) the use of an interface by changing a registry, as well as permits (or prohibits) the use of an application by changing the permission of an executable file. Also, the setting unit 5 sets the use time of the apparatus for the user, for example, by registering a shutdown command in a scheduler (e.g., one included with the operation system) so that the shutdown command is executed at a predetermined time. Also, the setting unit 5 may make a setting in accordance with range information changed by the range information change unit 6.

The range information change unit 6 changes the range information to change the use range of the information processing apparatus 1 already set by the setting unit 5 for the user. Like the range information acquisition unit 4, the range information change unit 6 may present an entry screen to the administrator and change the range information using information entered by the administrator on the entry screen or may change the range information by overwriting a file in which the use range is defined with a new definition file.

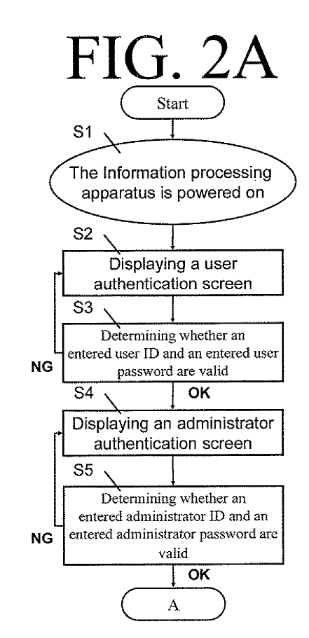

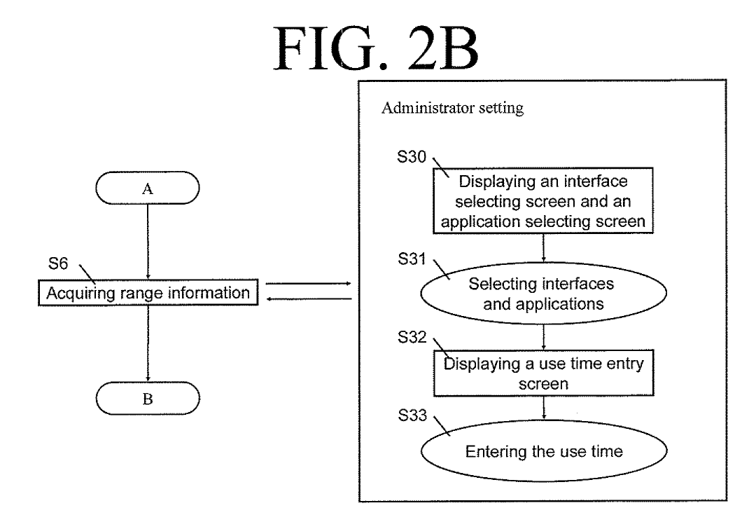

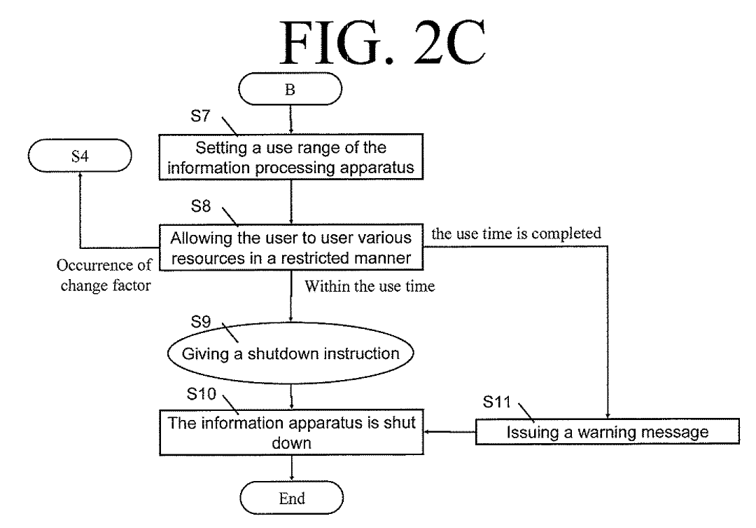

FIGS. 2A, 2B and 2C are flowcharts showing processes performed by the information processing apparatus 1. Note that steps shown using ellipses in the flowchart are processes performed by the user or administrator and steps shown using rectangles are processes performed by the information processing apparatus 1 (or a functional block of the information processing apparatus 1).

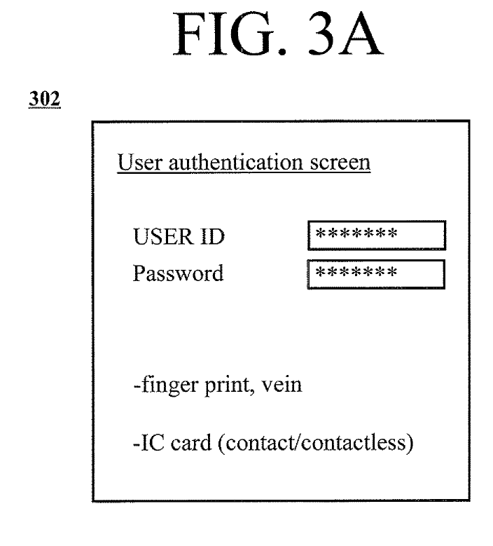

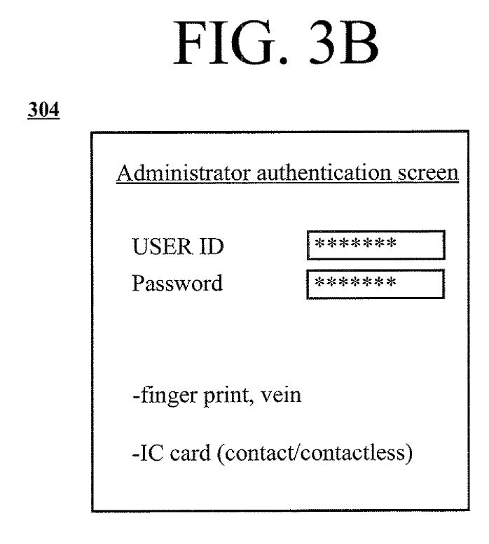

First, the information processing apparatus 1 is powered on by the user (step S1) and then the user authentication unit 2 displays a user authentication screen requesting the user to enter a user ID and a password thereon as shown in FIGS. 3A and 3B (step S2). If the information processing apparatus 1 includes an authentication mechanism for performing an authentication method such a biometric authentication method using fingerprints or veins or an authentication method using an IC card (contact-type/non-contact-type) as described above, the information processing apparatus 1 may perform authentication using such an authentication method.

The user authentication unit 2 acquires a user ID and a password entered by the user via the user authentication screen (step S3). If either of the user ID and password is not valid (authentication NG in step S3), the user authentication unit 2 outputs a predetermined message indicating an authentication failure and the flowchart returns to step S2. If both the user ID and password are valid (authentication OK step S3), the administrator authentication unit 3 displays an administrator authentication screen 304 (step S4). Note that the administrator authentication screen 304 is similar to the user authentication screen 302 (see the administrator authentication screen 304 shown in FIG. 3B). Also, if the information processing apparatus 1 includes an authentication mechanism as described above, the administrator authentication unit 3 may perform authentication using a biometric authentication method or an authentication method using an IC card.

Like the user authentication unit 2, the administrator authentication unit 3 also determines whether an entered user ID and an entered password are valid (step S5). If either of the user ID and password is not valid (authentication NG in step S5), the flowchart returns to step S4 and the administrator authentication unit 3 urges the administrator to enter a user ID and a password again. If both the user ID and password are valid (authentication OK in step S5), the range information acquisition unit 4 acquires range information (step S6).

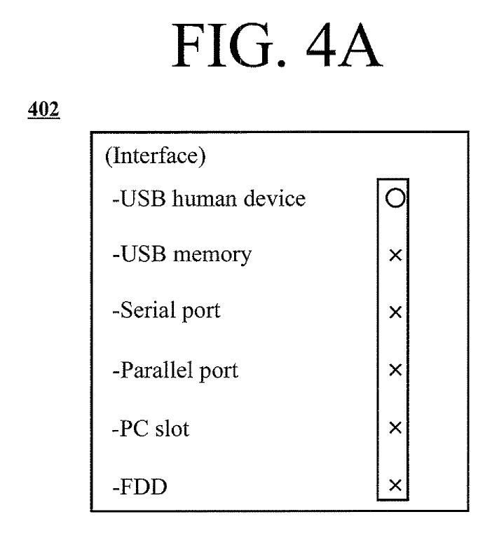

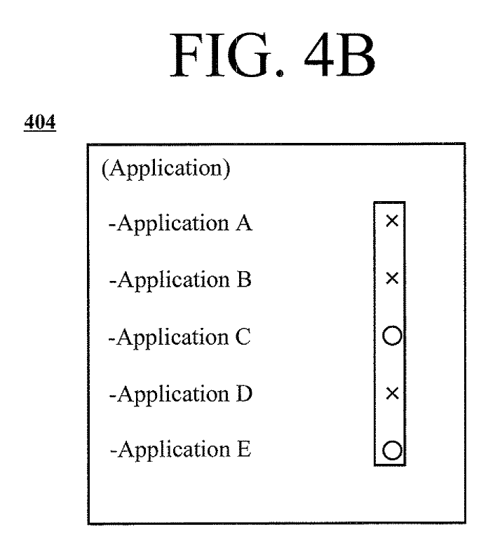

The range information acquisition unit 4 presents an entry screen to the administrator and acquires information entered by the administrator on the entry screen, as range information. Specifically, first, the range information acquisition unit 4 displays an interface selection screen 402 and an application selection screen 404 (step S30) and the administrator selects interfaces and applications whose use is to be permitted or prohibited (step S31). Thus, the range information acquisition unit 4 acquires range information. FIGS. 4A and 4B show examples of such selection screens. An interface selection screen 402 shown in FIG. 4A indicates that the administrator has selected interfaces to be permitted or prohibited, that is, has determined whether use of each of a USB human device, a USB memory, a serial port, a parallel port, a PC slot, and a flexible disk drive (FDD) should be permitted or prohibited. Thus, the range information acquisition unit 4 determines the range of use of hardware by the user. As such, an application selection screen 404 shown in FIG. 4B indicates that the administrator has selected applications to be permitted or prohibited. Thus, the range information acquisition unit 4 determines the range of use of software by the user.

Subsequently, the range information acquisition unit 4 displays a use time entry screen requesting the administrator to enter the time within which the user may use the information processing apparatus (hereafter referred to as a “use time”) (step S32).

Subsequently, the administrator enters the use time (step S33). Thus, the range information acquisition unit 4 acquires range information regarding the use time. While the range information acquisition unit 4 acquires, as the use time, a time period during which the user may continuously use the apparatus from a predetermined reference time of day (e.g., a time of day at which the administrator is successfully authenticated), it may acquire times of day (e.g., 9:00 and 17:30) between which the user may use the apparatus, as the use time.

While the range information acquisition unit 4 displays the entry screen and acquires the information entered by the administrator as range information in this embodiment, the information processing apparatus 1 may be previously provided with a file in which the use range of the apparatus for the user is defined and the range information acquisition unit 4 may acquire the file as range information.

The setting unit 5 sets the use range of the information processing apparatus 1 for the user in accordance with the range information acquired as described above (step S7). Specifically, the setting unit 5 sets the use range by changing the settings of registries corresponding to interfaces whose use is to be permitted (or prohibited), changing the permission of executable files of applications whose use is to be permitted (or prohibited), and registering a predetermined stop command in a scheduler.

According to the settings made by the setting unit 5, the operating system of the information processing apparatus 1 allows the user to use various resources (hardware and software) in a restricted manner (step S8). For example, if the use range is set in accordance with the selections shown in FIGS. 4A and 4B, use of applications A, B, and D as well as use of the USB memory, serial port, and parallel port, PC slot, and FDD is prohibited.

If the user gives a shutdown instruction to the information processing apparatus 1 within the use time of the apparatus set for the user (step S9), the system is stopped and the information processing apparatus 1 is shut down (step S10). On the other hand, if the use time set by the setting unit 5 is completed (use time completion in step S8), the information processing apparatus 1 issues a warning message (step S11) and is then shut down (step S10).

If there occurs a factor that changes the use range when the user is using the information processing apparatus 1 (occurrence of change factor in step S8), the administrator authentication unit 3 authenticates the administrator again (flowchart returns to step S4). If the authentication of the administrator succeeds (step S5), the range information change unit 6 changes the range information being used currently (step S6). Specifically, like the range information acquisition unit 4, the range information change unit 6 displays an entry screen and then acquires information on interfaces, applications, and use time entered by the administrator as new range information. Then, the range information acquisition unit 4 changes the existing range information to the new range information (steps S30 to S33).

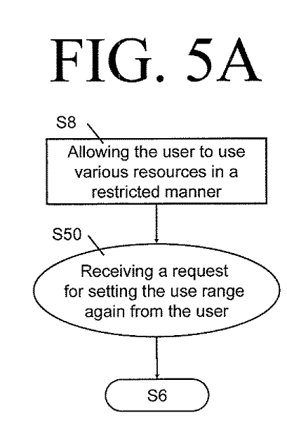

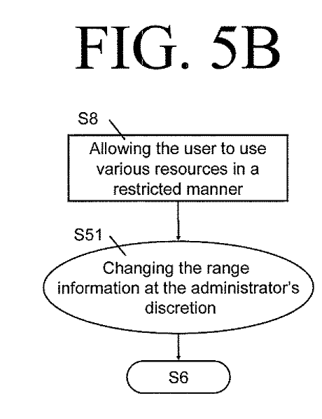

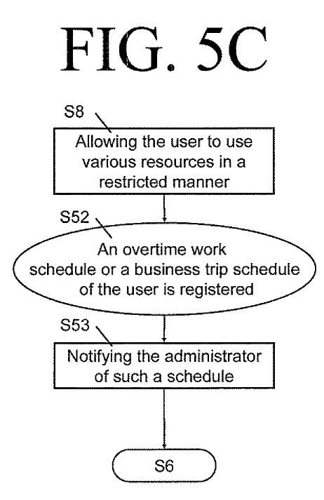

Referring now to FIGS. 5A, 5B and 5C, cases where a change factor occurs will be described. In case 1, the administrator receives a request for setting the use range again from the user (step S50) and then the range information is changed. In case 2, the administrator changes the range information at the administrator's discretion in accordance with the work situation of the user (e.g., occurrence of overtime work or a business trip of the user) (step S51). In case 3, an overtime work schedule or a business trip schedule of the user is registered in an external schedule system (step S52). Then, the schedule system notifies the administrator of such a schedule (step S53) so that the range information is changed.

The administrator authentication unit 3 is also allowed to authenticate the administrator even if the administrator is not present in the vicinity of the information processing apparatus 1. In that case, after the user authentication unit 2 successfully authenticates the user, the administrator authentication unit 3 sends an approval request to an information processing apparatus being used by the administrator who is at a distance. Then, the administrator creates an approval file (a file in which the user ID and password of the administrator and range information are encrypted) using the information processing apparatus and sends the created approval file to the administrator authentication unit 3. The administrator authentication unit 3 decrypts the encrypted file approval file and authenticates the administrator using the decrypted approval file.

While the use range of the information processing apparatus 1 with respect to the user according to this embodiment includes whether use of each of interfaces and applications is permitted (or prohibited) and the time within which the user may use the apparatus, this use range is illustrative only and various use ranges may be set. For example, use of a predetermined TCP/UDP port of the information processing apparatus 1 may be permitted (or prohibited), or an application-related use range such as making a predetermined URL viewable using a WEB browser or allowing sending or receiving of emails to or from only a predetermined email address may be set. Also, a use range may be set such that use of the information processing apparatus 1 is permitted (prohibited) only when a predetermined condition is met. For example, a use range may be set such that use of a predetermined application is permitted when a USB memory is inserted into the information processing apparatus 1.

According to this embodiment, the following advantages are obtained.

According to the aspects of the present technique, the range of use of the information processing apparatus by the user is restricted by the administrator. Also, only after the authentication of the administrator succeeds, the user is permitted to use the apparatus. Further, the security level is increased.

After authenticated successfully, the administrator is allowed to make settings regarding interfaces and applications that the administrator needs to make with respect to the user. Therefore, the administrator need not monitor the user thereby reducing the load imposed on the administrator.

Also, even if the user successfully takes the information processing apparatus outside without obtaining permission from the administrator, the user cannot use the apparatus, since the administrator must be authenticated before the user uses the apparatus. This prevents leakage of information.

Also, in case that the user loses the information processing apparatus according to this embodiment and the third party acquires the apparatus, the third party cannot easily use the information processing apparatus, since the user and at least one administrator must be authenticated before the third party uses the apparatus and thus the security level is increased.

Also, according to this embodiment, the system administrator or section manager is allowed to manage an information processing apparatus being used by the user even when the user is making a business trip or out of office.

Also, a program for causing a computer serving as the information processing apparatus 1 to perform the above-described steps may be provided as a use range setting program. The program is stored in a computer-readable recording medium and causes a computer serving as the information processing apparatus 1 to perform the above-described steps. Among such computer-readable recording media are internal storage devices incorporated into a computer, such as a ROM and a RAM, transportable storage media such as a CD-ROM, a flexible disk, a DVD disk, a magneto-optical disk, and an IC card, a database for storing a computer program, another computer or a database included therein, and a transmission medium in a line.

What is claimed is:

1. A method of controlling an information apparatus comprising:
performing authentication of a user of the information apparatus;
performing authentication of an administrator of the information apparatus;
determining a range of available functions of the information apparatus corresponding to successful authentication of the user and the administrator; and
permitting the user to utilize the range of available functions of the information apparatus.

2. The method of claim 1, further comprising changing the range of available functions.

3. The method of claim 1, further comprising displaying an image for setting the range of available functions.

4. The method of claim 1, wherein the range of available functions is corresponded to hardware of the information apparatus.

5. The method of claim 1, wherein the range of available functions is corresponded to software of the information apparatus.

6. An information apparatus comprising:
a storage for storing information for a range of available functions of the information apparatus; and
a processor for performing authentication of a user of the information apparatus, for performing authentication of an administrator of the information apparatus, obtaining the information upon successful authentication of the user and the administrator and permitting the user to utilize the range of available functions of the information apparatus on the basis of the obtained information.

7. The information apparatus of claim 6, wherein the processor changes the information.

8. The information apparatus of claim 6, wherein the processor displays an image for setting the information.

9. The information apparatus of claim 6, wherein the information is corresponded to hardware of the information apparatus.

10. The information apparatus of claim 6, wherein the information is corresponded to software of the information apparatus.

11. A computer-readable recording medium that stores a computer program for controlling an information apparatus, according to a process comprising:
performing authentication of a user of the information apparatus;
performing authentication of an administrator of the information apparatus;
determining a range of available functions of the information apparatus corresponding to successful authentication of the user and the administrator; and
permitting the user to utilize the range of available functions of the information apparatus.

12. The computer-readable recording medium of claim 11, wherein the process further comprises changing the range of available functions.

13. The computer-readable recording medium of claim 11, wherein the process further comprises displaying an image for setting the range of available functions.

14. The computer-readable recording medium of claim 11, wherein the range of available functions is corresponded to hardware of the information apparatus.

15. The computer-readable recording medium of claim 11, wherein the range of available functions is corresponded to software of the information apparatus.
